(19) United States
(12) Patent Application Publication
(10) Pub. No.: US 2003/0103424 A1
(43) Pub. Date: Jun. 5, 2003

(54) Method of detecting peak value for focus jumps in optical disk devices

(76) Inventor: Yu-Hung Sun, Taipei (TW)

Correspondence Address: BIRCH STEWART KOLASCH & BIRCH, PO BOX 747, FALLS CHURCH, VA, 22040-0747, US

(21) Appl. No.: 09/998,135

(22) Filed: Dec. 3, 2001

(51) Int. Cl. G11B 7/095

(52) U.S. Cl. 369/44.27

(57) ABSTRACT

A method of detecting the peak value for focus jumps is adaptable for optical disk devices. When an optical disk device is in a closed-loop condition, and the laser beam focuses on the 0-reflection layer of a double layer DVD disc, switch the optical disk device to an open-loop condition and output focus kick voltage to move the focal point away from the 0-reflection layer, and decrease the focus error signal negatively. When the focal point is located between the 0-reflection layer and the 1-reflection layer, the focus error signal decreases positively until reaching 0, and focus brake voltage is output to decrease the focal point moving speed until focus error reaches a positive peak value. Then switch the optical disk device to the closed-loop for steadily locking the focal point on the 1-reflection layer to enhance the focus jump stability.

### FIELD OF THE INVENTION

The invention relates to a method of detecting the peak value for focus jumps in optical disk devices and particularly a method to detect the peak value of focus error signals of Digital Video Disc (DVD) double layer discs for switching to a closed loop control system to effectively enhance focus jump stability.

### BACKGROUND OF THE INVENTION

Conventional DVD discs generally can be categorized as single layer DVD discs (DVD5) 10 and double layer DVD discs (DVD9) 20, as shown in FIGS. 1A and 1B. Data are stored on the reflection layer. The single layer DVD disc 10 has only one reflection layer 11, while the double layer DVD disc 20 has two reflection layers, a 0-reflection layer 21 and a 1-reflection layer 22. The double layer DVD disc 20 has almost twice the data capacity of the single layer DVD disc 10.

Data reading principles of the pickup head of optical disk devices are discussed below with reference to FIG. 2. A laser diode 31 is used to generate a laser beam, which is directed to a beam splitter 32 and an object lens 33 to form a focal point 34. The position of the focal point 34 may be changed by moving the object lens 33 up or down with a focus actuator 35. The focal point 34 projecting on the disc generates a reflection light, which is directed to the beam splitter 32 and a photodetector 36. The photodetector 36 can obtain useful optical signals, such as focus error signals, radio frequency (RF) signals, etc.

In general, the focus actuator 35 is controlled by an open-loop control system 40 or a closed-loop control system 50. FIG. 3A illustrates an open-loop control system 40. Depending on their requirements, users can send control commands to a digital/analog processing circuit 41, which then generates control signals. The control signals are amplified by a drive circuit 42, which generates focus drive signals to directly drive the focus actuator 35 for moving the object lens 33 up or down. The photodetector 36 captures focus error signals through a RF amplifier 43 to represent the distance between the focal point 34 and the optical disc.

FIG. 3B shows a closed-loop control system 50, which is constructed similarly to the previously described open-loop control system 40. The difference is that with the former the focus error signals are transferred to the control command end to allow the focus actuator 35 to adjust the up or down movement based on the focus error signals to make the focal point 34 project precisely on the reflection layer.

Referring to FIG. 4, when retrieving data on the single layer DVD disc 10, the laser beam has to focus precisely and steadily on the reflection layer 11. To achieve this end, the open-loop control system 40 must be adopted to make the focus drive signals generate a triangular wave 61 and drive the object lens 33 up and down to search for the focal point 34. When the focal point of the laser beam passes the reflection layer 11, the focus drive signals will generate an S-type curve 62. The middle point of the S-type curve is the optimal focal point 34. In this situation, the radio frequency (RF) level signal is proximate to maximum value. Under such circumstances, switching the open-loop control system 40 to the closed-loop control system 50 will make the laser beam focus precisely and steadily on the reflection layer 11.

However, with the double layer DVD disc 20, data are stored separately on the 0-reflection layer 21 and 1-reflection layer 22. In order to read data in the different locations, the focal point 34 must jump from the 0-reflection layer 21 to the 1-reflection layer 22, or from the 1-reflection layer 22 to the 0-reflection layer 21. Such an operation of moving the focal point 34 to different layers is called a focus jump. As shown in FIG. 5, when the optical disk device jumps from the 0-reflection layer 21 to the 1-reflection layer 22 for a focus jump operation, the closed-loop control system 50 is first switched to the open-loop control system 40, and the focus drive signal outputs a focus kick pulse 71. After waiting T for a delay time 72, the focus drive signal again outputs a focus brake pulse 73. The time intervals 74 and 75, and voltage 76 and 77 of the focus kick pulse and the focus brake pulse must be planned and adjusted properly in advance. After adjusting properly, when the focus brake pulse 73 ends, the focal point 34 is proximate to the 1-reflection layer 22. The open-loop control system 40 is then switched to the closed-loop control system 50 to lock the focal point 34 steadily on the 1-reflection layer 22.

The method set forth above is adaptable only to low speed optical disk devices. For high-speed optical disk devices, the high-speed rotation of the disc will cause wobbling and result in variations of the focal point. The pre-planned and pre-adjusted focus kick pulse 71 and focus brake pulse 73 in the open-loop control system 40 do not always coincide with the optimal focus switching time. This could result in unstable focus jumps.

As previous discussed, conventional focus jump methods still have deficiencies in actual applications. There is thus room for improvement.

### SUMMARY OF THE INVENTION

In view of the foregoing disadvantages, the primary object of the invention is to provide a method to detect the focus error peak value to ensure that switching to the closed-loop is done at a selected constant distance to enhance focus jump stability.

The foregoing, as well as additional objects, features and advantages of the invention will be more readily apparent from the following detailed description, which proceeds with reference to the accompanying drawings. The drawings are only to serve for reference and illustrative purposes, and are not intended to limit the scope of the invention.

### BRIEF DESCRIPTION OF THE DRAWINGS

FIG. 1A is a schematic cross section of a conventional single layer DVD disc.

FIG. 1B is a schematic cross section of a conventional double layer DVD disc.

FIG. 2 is a schematic view of the focusing operation of a pickup head for a conventional optical disk device.

FIG. 3A is a block diagram of a conventional open-loop control system.

FIG. 3B is a block diagram of a conventional closed-loop control system.

FIG. 4 is a focus on signal chart of a conventional single layer DVD disc.

FIG. 5 is a focus jump signal chart of a conventional double layer DVD disc.

FIG. 6 is a schematic view of the invention showing the relationship between various focus jumps with matching focus positions and signals.

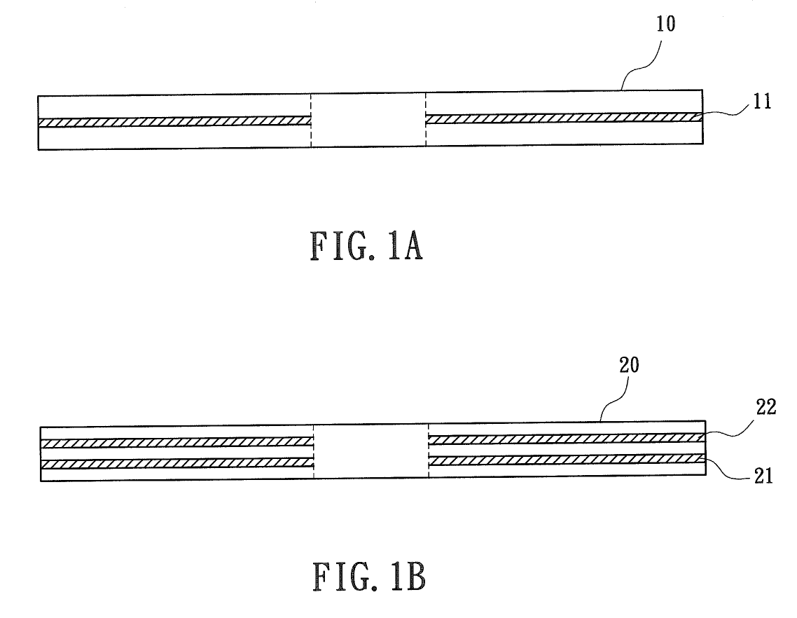

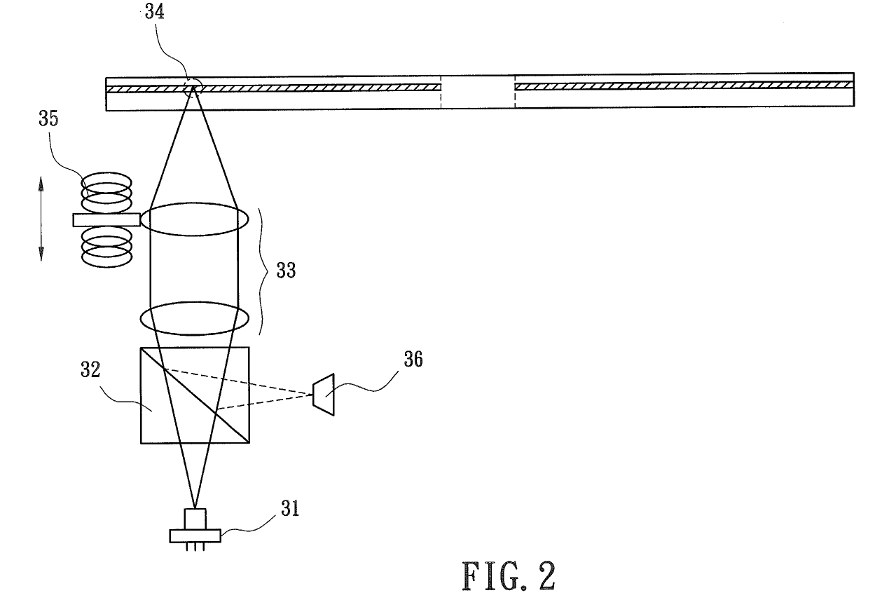

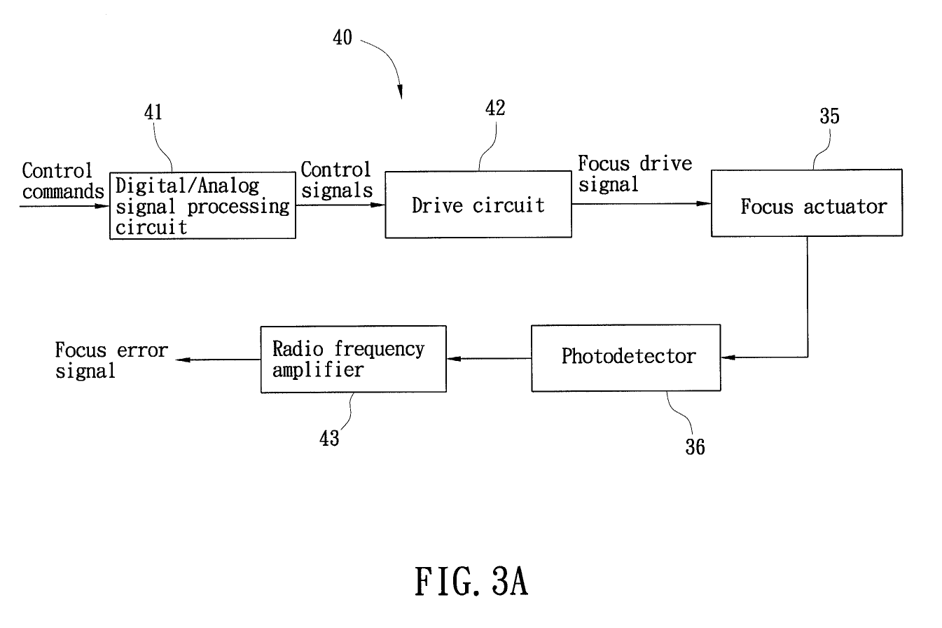

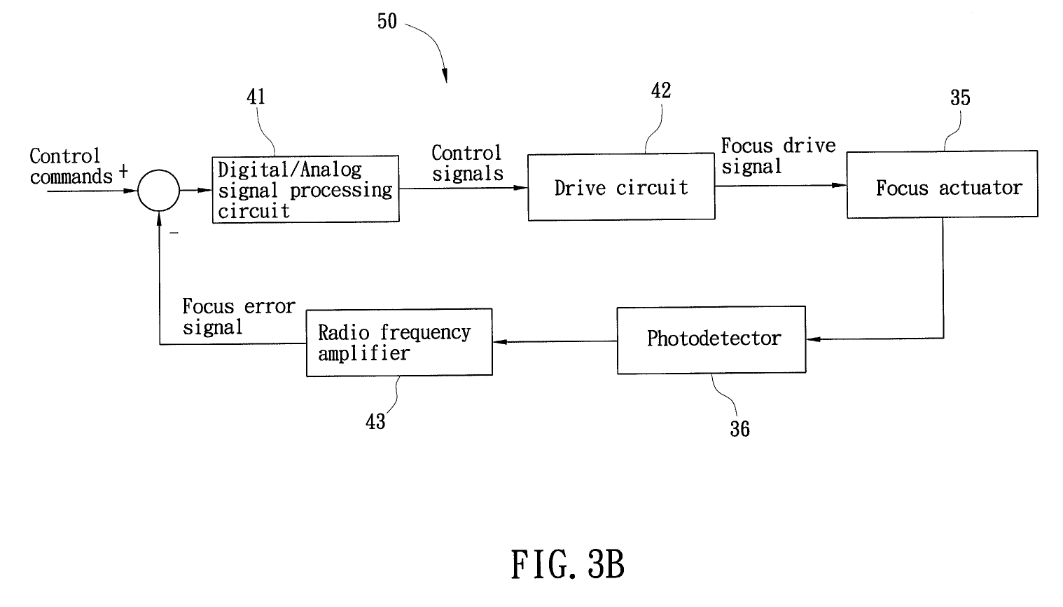

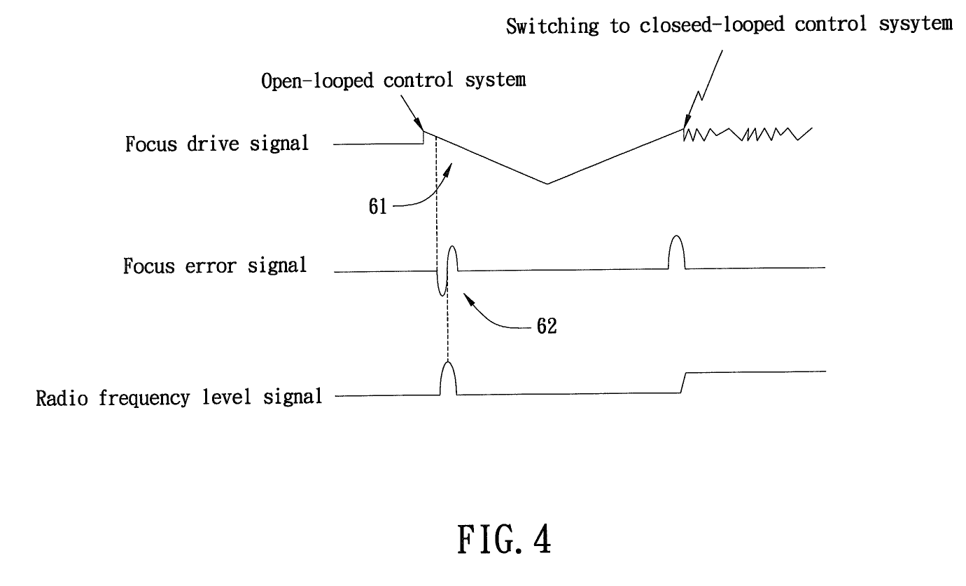

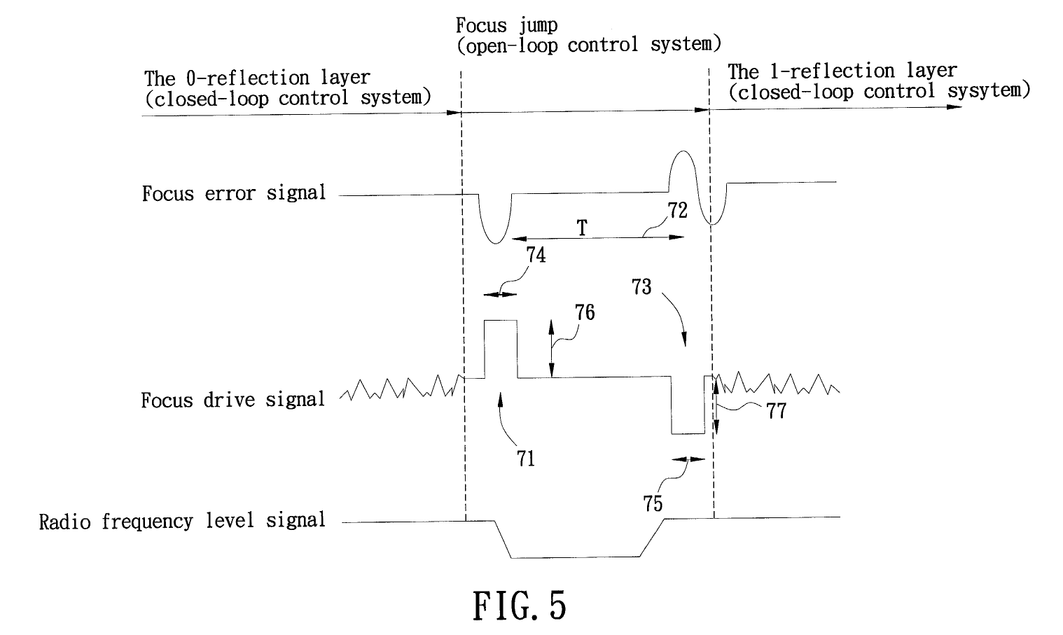

### DETAILED DESCRIPTION OF THE INVENTION

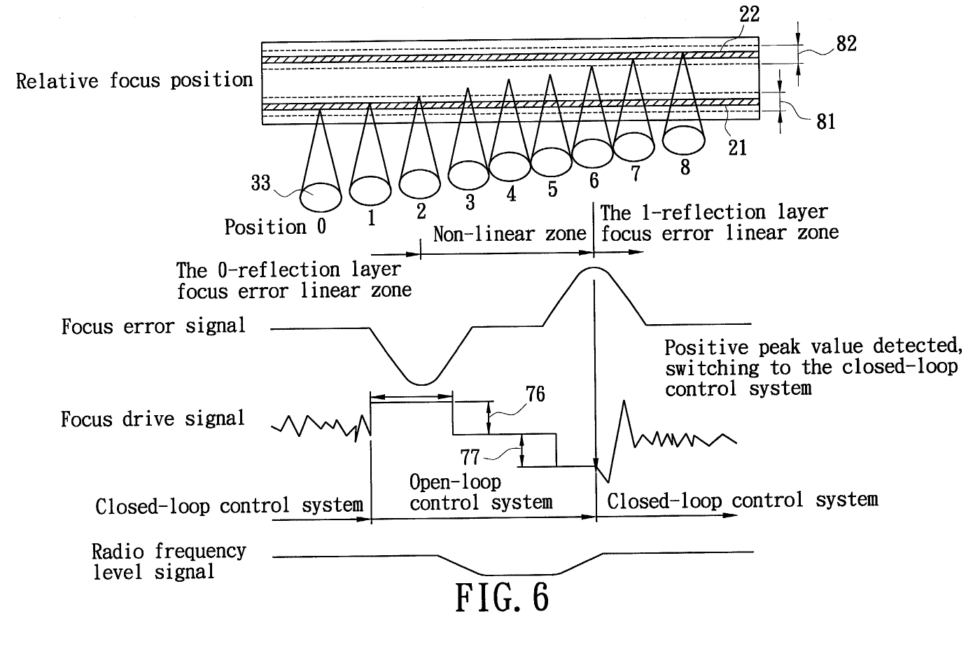

Referring to FIG. 6, the invention aims to provide a method to detect the peak value for focus jumps in optical disk devices to allow the focal point to jump from the 0-reflection layer to the 1-reflection layer. The method comprises the following steps:

when the object lens 33 is located between positions 0 and 1, the laser beam focuses steadily on the 0-refelction layer 21, as it is under closed-loop control system 50 conditions;

when the object lens 33 is moved to position 1, the closed-loop control system 50 is switched to the open-loop control system 40, and outputs focus kick voltage 76. The focal point 34 starts to move upwards and away from the 0-reflection layer, and the focus error signal decreases negatively;

when passing position 2, the focal point is moved away from the 0-layer focus error linear zone, enters into a non-linear zone, and the focus error signal increases positively;

when the object lens 33 is moved between positions 3 and 5, the distance between the focal point 34 and the 0-reflection layer or 1-reflection layer is too large, hence the focus error is 0;

when the object lens 33 is moved between positions 5 and 6, the focus drive signal outputs focus brake voltage 77, decreases the kick velocity of the object lens 33, and the focus error signal increases positively;

when the object lens 33 is moved to position 6, the focus error reaches positive peak value, and the focus error starts to enter the 1-layer focus error linear zone. The focus error signal shows the actual distance between the focal point 34 and the 1-reflection layer 22. Hence, the open-loop control system 40 may be switched to the closed-loop control system 50, and with the closed-loop control system 50 the focal point 34 is smoothly switched and locked on the 1-reflection layer 22.

In contrast, for a focus jump downward, the focal point is jumps from the 1-reflcetion layer 22 to the 0-reflection layer 21 (not shown in the drawing). After kick brake voltage 77 is applied, inspection of the focus error signal begins. When the focus error signal reaches negative peak value, it indicates having entered into the 0-layer focus error linear zone. Switching to the closed-loop control system 50 may then be performed immediately, and through the closed-loop control system 50 the focal point 34 is smoothly switched and locked on the 0-reflection layer 21.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A method of detecting peak value for focus jump in an optical disk device to move a focal point from a 0-reflection layer to a 1-reflection layer, the method comprising the steps of:
a. setting initially the optical disk device in a closed-loop control system to steadily focus laser beam on the 0-reflection layer;
b. switching to an open-loop control system and outputting a focus kick voltage to move the focal point away from the 0-reflection layer and decrease focus error signal negatively;
c. moving the focal point from the 0-reflection layer to the 1-reflection layer, and increasing the focus error signal positively until focus error reaching 0;
d. moving the focal point towards the 1-reflection layer and outputting a focus brake voltage to decrease the moving speed; and
e. switching the open-loop control system to the closed-loop control system when the focus error reaching a positive peak value for steadily locking the focal point on the 1-reflection layer to enhance the focus jump stability.

2. A method of detecting peak value for focus jump in an optical disk device to move a focal point from a 1-reflection layer to a 0-reflection layer, the method comprising the steps of:
a. setting initially the optical disk device in a closed-loop control system to steadily focus laser beam on the 1-reflection layer;
b. switching to an open-loop control system and outputting a focus brake voltage to move the focal point away from the 1-reflection layer and increase focus error signal positively;
c. moving the focal point from the 1-reflection layer to the 0-reflection layer, and increasing the focus error signal negatively until focus error reaching 0;
d. moving the focal point towards the 0-reflection layer and outputting a focus kick voltage to decrease the moving speed; and
e. switching the open-loop control system to the closed-loop control system when the focus error reaching a negative peak value for steadily locking the focal point on the 0-reflection layer to enhance the focus jump stability.
